(19) United States
(12) Patent Application Publication
(10) Pub. No.: US 2020/0213674 A1
(43) Pub. Date: Jul. 2, 2020

(54) METHOD FOR THE COMBINED BROADCASTING OF A TELEVISION PROGRAMME AND AN ADDITIONAL MULTIMEDIA CONTENT

(71) Applicant: SAGEMCOM BROADBAND SAS, Rueil Malmaison (FR)

(72) Inventor: Mathieu ABRAHAMI, Rueil Malmaison (FR)

(73) Assignee: SAGEMCOM BROADBAND SAS, Rueil Malmaison (FR)

(21) Appl. No.: 16/621,098

(22) PCT Filed: Jul. 9, 2018
(86) PCT No.: PCT/EP2018/068497

§ 371 Date: Dec. 10, 2019

(30) Foreign Application Priority Data
Jul. 13, 2017 (FR) 1756696

(51) Int. Cl. H04N 21/4722; H04N 21/435; H04N 21/81; H04N 21/433; H04N 21/462; H04N 21/41; H04N 21/6587

(52) U.S. Cl. CPC H04N 21/4722; H04N 21/435; H04N 21/8133; H04N 21/6587; H04N 21/462; H04N 21/4104; H04N 21/4333

(57) ABSTRACT

Television programmes have changed over the past years. It happens in fact that these programmes are enhanced by additional contents that a user can access by means of his television set. However, in order to go further in the enhancement, it may be wished to enhance a television programme with contents that can be played, executed or broadcast on devices other than the television set displaying the television programme. In this case there is a risk that the broadcasting of the additional content on another device may compete with the broadcasting of the television programme on the television set that it is supposed to enhance. The invention makes it possible for the additional content and the television programme not to be in competition. Thus, when the additional content (313) is broadcast, the television programme is paused (309) and resumes (317) only when use of the additional content has ended.

The present invention relates to a method for the combined broadcasting of a multimedia programme and multimedia content, the multimedia programme being broadcast continuously to a first client device and the multimedia content being intended to be played on at least one second client device. The present invention also relates to devices and a system implementing the method.

Spurred on by the widespread use of computers, smartphones and tablets, the ways of consuming television applications are changing. Thus more and more users of television applications wish to be able to watch programmes at times chosen by them and to interact with these programmes. Whereas playing a television programme at a required time has become normal by virtue of applications making it possible to replay programmes, interacting with a television programme is merely at its infancy.

HbbTV (Hybrid Broadcast Broadband TV) is both an industrial standard and an initiative for harmonising television applications and web applications in the supply of television programmes to end users through connected televisions and decoding devices (set-top boxes).

The HbbTV standard enables television channels to publish additional contents in addition to and accompanying their television programmes. There mainly exist two ways of using HbbTV:
A first way, known as broadcasting, in which an additional multimedia content (simply referred to as additional content hereinafter) is transmitted in the data stream containing the television programme, whatever the method of transmitting the data stream (TDT (terrestrial digital television), cable, satellite). No connection to the internet is then necessary. Thus a client device (i.e. a connected television set, a decoding device) receiving this television programme conjointly receives the additional content. Generally this application is indicated to the viewer by a notification (i.e. a signal) that appears on the screen of the television set inviting him to take an action (for example press a button on his remote control) in order to access the additional content. Many services are thus possible, for example broadcasting of information magazines, files contextual with the programme, alerts of all kinds, etc;
A second method of use (referred to as broadband) concerns client devices connected to the internet. Television programme providers (i.e. TV channels) can enhance their services with on-line contents published by themselves. Thus a user can, in addition to the television programmes, access applications related to the television programmes: EPG (electronic programme guide), magazines, VOD (video on demand), replay television, enhanced broadcasts, direct voting, integration of social networks in television programmes, etc.

In order to go further in enhancements of television programmes, additional contents could be accessed on client devices other than a connected television set. It would be possible for example to access virtual-reality applications from a virtual-reality helmet, access a soundtrack or a musical piece from a smartphone or a tablet, or obtain a gaming or voting application also on a smartphone or a tablet. However, the television programme and the additional content are not necessarily intended to be played at the same time. For example, a user wearing a virtual-reality helmet may have difficulty in watching a television programme displayed on the television set at the same time without losing part of the information broadcast in the television programme. In a similar way, broadcasting an additional soundtrack on a smartphone in parallel with an original soundtrack of a television programme broadcast on a television set could create cacophony. In the current situation, playing an additional content related to a television programme on a client device (virtual-reality helmet, smartphone, tablet, etc.) has no influence on the broadcasting of the television programme, so that, whereas one objective of the additional content is to enhance a television programme, the broadcasting, use or execution thereof comes into competition with the television programme.

It is desirable to overcome these drawbacks of the prior art. It is in particular desirable to provide a solution that makes it possible to combine the broadcasting of a television programme on a first client device such as a television set and the broadcasting, use or execution of additional content on a second client device such as a smartphone, a tablet or a virtual-reality helmet without the television programme and the additional content being in competition.

It is also desirable to provide a solution that is simple to implement at low cost.

According to a first aspect of the present invention, the present invention relates to a method for the combined broadcasting of a first television programme and additional multimedia content, the first television programme being broadcast continuously between a first server and a first client device via a decoding device, the decoding device receiving a data stream comprising the first television programme and extracting the first television programme from said data stream in order to supply it to the first client device, the additional multimedia content being stored on a second server and being intended to be played on at least one second client device, the first and second server being able to be two distinct servers or one and the same server, the method comprising, when it is implemented by the decoding device, extracting information representing the additional multimedia content from the data stream and, for each second client device, supplying, to the user of said second client device, by means of the first client device, a signal indicating that it is possible to obtain the additional multimedia content; receiving a request, referred to as a request for information, with a view to obtaining information on the additional multimedia content, from at least one second client device, said information comprising an address of the second server; transmitting said information on the additional multimedia content to each second client device that sent a request for information; as soon as a first request for information is received, pausing the supply of at least one component of the first television programme at least as long as a request, referred to as the final request, indicating an end of use of the additional multimedia content is not received by the decoding device from each second client device that sent a request for information.

Thus the television programme and the additional content are not in competition since the television programme is, at least partly, paused as long as the additional content is being played, executed or broadcast.

According to one embodiment, following the reception of a final request, the decoding device resumes the supply of each component of the first television programme paused.

According to one embodiment, the additional multimedia content is content with which each user of a second client device receiving this additional multimedia content can interact and for which a result of interaction is obtained at the end of use of said additional multimedia content, and the decoding device receives the interaction result and determines an action to be taken involving the first client device according to the interaction result.

According to one embodiment, the action to be taken comprises a supply of a second television programme included in the data stream to the first client device in replacement for the first television programme and/or a supply of at least one component of the first television programme different from each component paused to the first client device in replacement for or in addition to at least one component paused and/or a starting of an application on the first client device.

According to a second aspect of the invention, the invention relates to a method for the combined broadcasting of a first television programme and additional multimedia content, the first television programme being broadcast continuously between a first server and a first client device via a decoding device, the decoding device receiving a data stream comprising the first television programme and extracting the first television programme from said data stream in order to supply it to the first client device, the additional multimedia content being stored on a second server and being intended to be played on at least one second client device, the first and second server being able to be two distinct servers or one and the same server, the method comprising, when it is implemented by a second client device: transmitting a request, referred to as a request for information, to the decoding device with a view to obtaining information on the additional multimedia content, said information comprising an address of the second server, said request for information being transmitted by an action of a user of the second client device following an obtaining, by said user, of a signal indicating that it is possible to obtain the additional multimedia content, the signal having been sent by the first client device following an extraction from the data stream of information representing the additional multimedia content, the request for information being able to cause a pausing, by the decoding device, of the supply of at least one component of the first television programme to the first client device; receiving said information on the additional multimedia content from the decoding device; transmitting a request to obtain the additional multimedia content to the second server; using the additional multimedia content following the reception thereof from the second server device; transmitting a request, referred to as the final request, indicating an end of use of the additional multimedia content to the decoding device, said final request being able to cause an action of the decoding device involving the first client device.

According to one embodiment, the additional multimedia content is content with which the user of the second client device can interact and for which an interaction result is obtained at the end of use of said additional multimedia content, and the second client device transmits the interaction result to the decoding device, the action taken by the decoding device being dependent on the interaction result.

According to a third aspect of the invention, the invention relates to a method for the combined broadcasting of a first television programme and additional multimedia content, the first television programme being broadcast continuously between a first server and a first client device via a decoding device, the decoding device receiving a data stream comprising a first television programme and extracting the first television programme from said data stream in order to supply it to the first client device, the additional multimedia content being stored on a second server and being intended to be played on at least one second client device, the first and second server being able to be two distinct servers or one and the same server, part of the method implemented by the decoding device comprising: extracting information representing the additional multimedia content from the data stream and, for each second client device, supplying to the user of said second client device, by means of the first client device, a signal indicating that it is possible to obtain the additional multimedia content; receiving a request, referred to as a request for information, with a view to obtaining information on the additional multimedia content from at least one second client device, said information comprising an address of the second server; transmitting said information on the additional multimedia content to each second client device that sent a request for information; as soon as a first request for information is received, pausing the supply of at least one component of the first television programme at least as long as a request, referred to as the final request, indicating an end of use of the additional multimedia content has not been received by the decoding device from each second client device that sent a request for information; and a part of the method comprising, for each second client device implementing the method: transmitting the request for information to the decoding device with a view to obtaining the information on the additional multimedia content, said request for information being transmitted by an action of a user of the second client device following an obtaining, by said user, of the signal indicating that it is possible to obtain the additional multimedia content sent by the first client device; receiving said information on the additional multimedia content from the decoding device; transmitting a request to obtain the additional multimedia content to the second server; using the additional multimedia content following reception thereof from the second server device; transmitting the final request to the decoding device.

According to a fourth aspect of the invention, the invention relates to a decoding device continuously broadcasting a television programme to a first client device, the decoding device receiving a data stream comprising a first multimedia stream coming from a first server and extracting the first television programme from said data stream in order to supply it to the first client device, the decoding device comprising:

extraction means for extracting information representing an additional multimedia content from the data stream, the additional multimedia content being stored on a second server and being intended to be played on at least one second client device; the first and second server being able to be two distinct servers or one and the same server, supply means for supplying, to each user of a second client device, by means of the first client device, a signal indicating that it is possible to obtain the additional multimedia content; means for receiving a request, referred to as a request for information, with a view to obtaining information on the additional multimedia content, from at least one second client device, said information comprising an address of the second server; transmission means for transmitting said information on the additional multimedia content to each second client device that sent a request for information; means for pausing the supply of at least one component of the first television programme as soon as a first request for information is received, the pausing being activated at least as long as a request, referred to as the final request, indicating an end of use of the additional multimedia content, is not received by the decoding device from each second client device that sent a request for information.

According to a fifth aspect of the invention, the invention relates to a client device, referred to as the second client device, able to connect to a decoding device continuously broadcasting a television programme to a first client device, the decoding device receiving a data stream coming from a first server comprising the first television programme and extracting the first television programme from said data stream in order to supply it to the first client device, the first client device comprising: transmission means for transmitting to the decoding device a request, referred to as a request for information, with a view to obtaining information on an additional multimedia content, the additional multimedia content being stored on a second server, the first and second server being able to be two distinct servers or one and the same server, said information comprising an address of the second server, said request for information being transmitted by the action of a user of the second client device following an obtaining, by said user, of a signal indicating that it is possible to obtain the additional multimedia content, the signal having been sent by the first client device following an extraction from the data stream of information representing the additional multimedia content, the request for information being able to cause a pausing by the decoding device of the supply of at least one component of the first television programme to the first client device; reception means for receiving said information on the additional multimedia content from the decoding device; transmission means for transmitting a request to obtain the additional multimedia content to the second server; use means for using the additional multimedia content following reception thereof from the second server device; transmission means for transmitting a request, referred to as the final request, indicating an end of use of the additional multimedia content to the decoding device, said final request being able to cause an action involving the first client device by the decoding device.

According to a sixth aspect of the invention, the invention relates to a system comprising a decoding device according to the fourth aspect and at least one client device according to the fifth aspect.

According to a seventh aspect of the invention, the invention relates to a computer program comprising instructions for the implementation, by a device, of the method according to the first aspect or the method according to the second aspect, when said program is executed by a processor of said device.

According to an eighth aspect of the invention, the invention relates to storage means, storing a computer program comprising instructions for the implementation, by a device, of the method according to the first aspect or the method according to the second aspect, when said program is executed by a processor of said device.

The features of the invention mentioned above, as well as others, will emerge more clearly from a reading of the following description of an example embodiment, said description being given in relation to the accompanying drawings, among which:

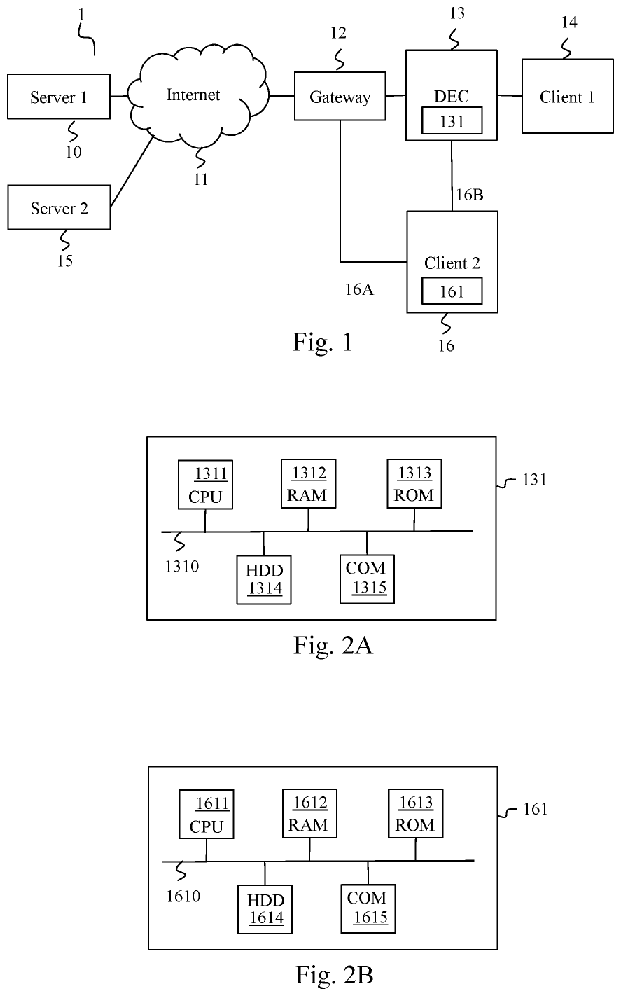

FIG. 1 illustrates schematically an example of a system in which the invention is implemented;

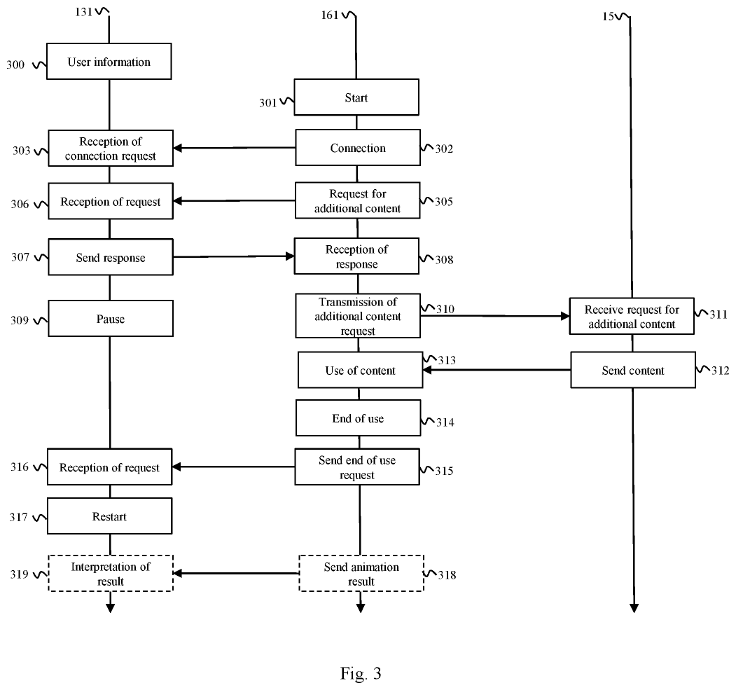

FIG. 2A illustrates schematically an example of hardware architecture of a decoding device according to the invention;

FIG. 2B illustrates schematically an example of hardware architecture of a client device according to the invention;

FIG. 3 illustrates schematically a first example of a method for the combined broadcasting of a television programme and additional multimedia content according to the invention; and

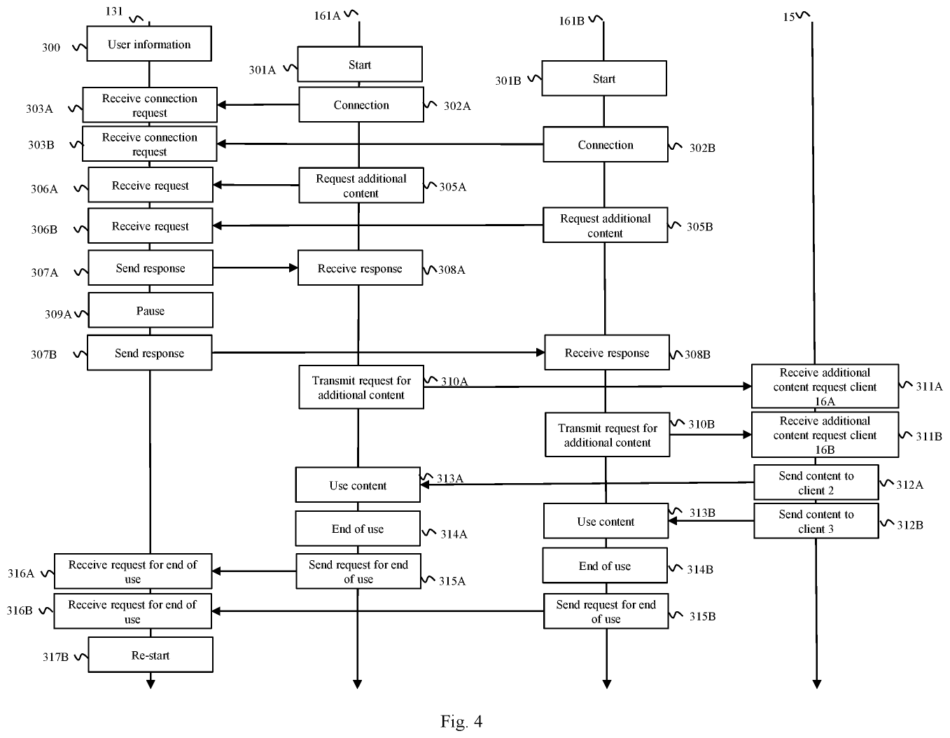

FIG. 4 illustrates schematically a second example of a method for the combined broadcasting of a television programme and additional multimedia content according to the invention.

Hereinafter, the invention is described in a context where a television programme such as a broadcast, a film or sport is broadcast on a first client device such as a television set. The invention also applies when the first client device is any device making it possible to play a television programme, such as a computer, a tablet, a smartphone or a video projector. Moreover, the invention is described in a context where the additional content is a virtual-reality content that is to be played by at least one second client device of the virtual-reality helmet type. The invention applies however to other additional contents that can be played on other types of second client device, such as a soundtrack (for example a soundtrack of a television programme in a language different from the language of the original soundtrack broadcast on a television set), a piece of music, a voting application or a gaming application that can be played on a smartphone, a tablet or a computer.

FIG. 1 illustrates schematically an example of a system 1 in which the invention is implemented.

The system 1 comprises a first server 10 that corresponds to a server of a television programme provider (i.e. a server of a TV channel). The server 10 is connected to a gateway 12 by means of a network 11. In the example in FIG. 1, the network 11 is the internet. The gateway 12 connects the network 11 to a local network (local area network (LAN)). Connected to the gateway 12 by means of the local network, there is a decoding device 13 (a set-top box) comprising a processing module 131. A first client device 14 is connected to the decoding device for example by a cabled connection such as a coaxial cable, a SCART cable or an HDMI cable.

The system 1 also comprises at least one second client device 16. The second client device is a virtual-reality helmet that can be connected to the gateway 12 and to the decoding device 13, for example by means of a wireless connection of the Wi-Fi type (ISO/IEC 8802-11). Each second client device comprises a processing module 161.

The system 1 further comprises at least one second server 15 able to store and transmit additional contents.

The first server 10 continuously broadcasts a data stream to the decoding device 13 in the form of an MPEG (Moving Picture Expert Group) transport stream (TS), for example in accordance with ISO/IEC 13818-1. The data stream comprises DVB (Digital Video Broadcasting) tables. A data stream TS may comprise a plurality of television programmes. Each television programme appears in the data stream in the form of a substream of compressed video data, at least one substream of compressed audio data and at least one substream of subtitle data. The DVB tables serve to define each of these substreams and to associate them with each other. There exist various types of DVB table, including DVB-SI (Service Information) tables that serve to define services associated with a television programme.

In the context of the invention, some DVB-SI tables contained in the data stream TS comprise information of the HbbTV type to indicate that additional content associated with a television programme is available and to give a server address where this additional content is situated (here the second server 15).

In one embodiment, the decoding device is connected to the first server 10 by a satellite link or a link of the TNT type. In this case, the television programmes do not pass through the internet 11 (and therefore do not pass through the gateway 12) but are received directly by the decoding device 13.

In one embodiment, the decoding device is integrated in the first client device 14. In this case, each second client device 16 is connected to the first client device 14 (and therefore to the decoding device 13) by means of a wireless connection. In this embodiment, each second client device 16 is also connected to the gateway 11.

In one embodiment, the additional content is also stored on the first server 10. In this case, the first server 10 and the second server 15 are one and the same server.

FIG. 2A illustrates schematically an example of hardware architecture of the processing module 131 of the decoding device 13. The processing module 131 then comprises, connected by a communication bus 1310: a processor or CPU (central processing unit) 1311; a random access memory RAM 1312; a read only memory ROM 1313; a storage unit or a storage medium reader such as an SD (Secure Digital) card reader 1314; a set of communication interfaces 1315 enabling the processing module 131 to communicate with other modules of the decoding device 13, including modules for communicating with the gateway 12, the first client device 14 and each second client device 16.

The processor 1311 is capable of executing instructions loaded in the RAM 1312 from the ROM 1313, from an external memory (not shown), from a storage medium, such as an SD card, or from a communication network. When the decoding device 13 is powered up, the processor 1311 is capable of reading instructions from the RAM 1312 and executing them. These instructions form a computer program causing the implementation, by the processor 1311, of a part relating to the decoding device 13 of the methods described in relation to FIGS. 3 and 4.

FIG. 2B illustrates schematically an example of hardware architecture of the processing module 161 of a second client device 16. The processing module 161 then comprises, connected by a communication bus 1610: a processor or CPU (central processing unit) 1611; a random access memory RAM 1612; a read only memory ROM 1613; a storage unit or a storage medium reader, such as an SD (Secure Digital) card reader 1614; a set of communication interfaces 1615 enabling the processing module 161 to communicate with other modules of the second client device 16, including modules for communicating with the gateway 12 and the decoding device 13.

The processor 1611 is capable of executing instructions loaded in the RAM 1612 from the ROM 1613, from an external memory (not shown), from a storage medium, such as an SD card, or from a communication network. When the client device 161 is powered up, the processor 1611 is capable of reading instructions from the RAM 1612 and executing them. These instructions form a computer program causing the implementation, by the processor 1611, of a part relating to the second client device 1611 of the method described in relation to FIGS. 3 and 4.

All or part of the method described in relation to FIGS. 3 and 4 can be implemented in software form by the execution of a set of instructions by a programmable machine, such as a DSP (digital signal processor) or a microcontroller, or be implemented in hardware form by a machine or a dedicated component, such as an FPGA (field-programmable gate array) or an ASIC (application-specific integrated circuit).

FIG. 3 illustrates schematically a first example of a method for the combined broadcasting of a television programme and additional multimedia content according to the invention.

We assume in the context of FIG. 3 that a user is in the process of viewing a television programme on a first client device 14 that is a television set. This programme is broadcast continuously by the first server 10 in a data stream TS comprising DVB-SI tables. The user has a second client device 16 that is a virtual-reality helmet.

The decoding device 13 and the second client 16 are able to communicate using a protocol of the RPC (Remote Procedure Call) type such as JSON-RPC (JavaScript Object Notation) or XML-RPC (eXtensible Markup Language), which makes it possible to exchange commands and structured information simply. The processing module 13 therefore implements an RPC server and the processing module 161 implements an RPC client.

In a step 300, the processing module 131 of the decoding device 13 detects and extracts, from the data stream TS comprising the television programme currently being broadcast on the television set 14, information representing the additional content. The information representing the additional content is in the form of a DVB-SI table comprising information of the HbbTV type. The HbbTV information indicates that additional content is available and indicates at least the address of the second server 15.

Following this extraction, the processing module 131 supplies to the user, by means of the television set 14, a signal, referred to as an information signal, indicating that it is possible to obtain the additional content. To do this, for example, the processing module 131 triggers a display on the television set 14 of an icon that the user identifies as a signal indicating to him that additional content is available.

In one embodiment, the information signal is an audible signal that the user identifies as a signal indicating to him that additional content is available.

In a step 301, following an obtaining of the information signal by the user, the user launches an application on the virtual-reality helmet 301. This application is used by the processing module 161 and implements an RPC client.

In a step 302, the processing module 161 causes a transmission, by the RPC client that it implements, of a request for connection to the RPC server implemented by the processing module 131.

In a step 303, the RPC server implemented by the processing module 131 receives the connection request and accepts it.

In a step 305, the processing module 161 causes the sending, by the RPC client that it implements, of a request, referred to as a request for information, to the RPC server implemented by the processing module 131 with a view to obtaining information on the additional content.

In a step 306, the RPC server implemented by the processing module 131 receives the request for information.

In a step 307, the RPC server implemented by the processing module 131 transmits said information on the additional content to the RPC client implemented by the processing module 161. This information comprises at least the address of the second server 15. The RPC server implemented by the processing module 131 knows in addition which television programme is being broadcast by the decoding device and knows in addition which DVB-SI table has caused the sending of the information signal. In one embodiment, the information on the additional content further comprises an identifier of the television programme and an identifier of the DVB-SI table that cause the sending of the information signal.

In a step 308, the RPC client implemented by the processing module 161 receives said information on the additional content.

In a step 309, as soon as the request for information is received, the processing module 131 pauses the supply of at least one component of the television programme at least as long as a request, referred to as the final request, indicating an end of use of the additional content has not been received by the decoding device 13 from the virtual-reality helmet 16. One of the components of the television programme is for example a video component transported in a compressed video data substream, an audio component transported by a compressed audio data substream or a subtitle component transported by a subtitle data substream. In the example in FIG. 3, it is the entire television programme that is paused as soon as the request for information is received. That is to say all the components of the television programme. The television set 14 therefore no longer displays the television programme as long as the user is using the additional content.

In parallel with this pausing of the television programme, the processing module 161 performs steps 310, 313, 314 and 315, enabling it to use the additional content.

In step 310, the processing module 161 transmits a request to obtain the additional content to the second server 15, for example in the form of an HTTP (Hypertext Transport Protocol) request, using the address of the second server 15. In one embodiment, this request to obtain comprises the identifier of the television programme currently being broadcast on the television set 14 and the identifier of the DVB-SI table that caused the sending of the information signal. These two identifiers enable the processing module 161 to indicate precisely to the second server 15 which additional content to send. It is assumed in fact that, in this embodiment, the second server 15 comprises a table matching each additional content that it stores with a television programme identifier and a DVB-SI table identifier. However, the request to obtain additional content could not include the identifier when, for example, the second server 15 comprises only one additional content.

In a step 311, the second server 15 receives the request to obtain the additional content.

In a step 312, the second server 15 transmits the additional content corresponding to the identifier of the television programme and to the identifier of the DVB-SI table received in the request for additional content to the processing module 161.

In step 313, the processing module 161 uses the additional content following reception thereof. In the example in FIG. 3, the additional content is a virtual-reality application depicting a virtual scene or world. The user then uses his virtual-reality helmet 16 to stroll in this scene.

In step 314, the user ends the use of the additional content. For example, he removes his virtual-reality helmet 16.

In step 315, the RPC client implemented by the processing module 161 transmits a final request indicating the end of the use of the additional multimedia content to the RPC server implemented by the processing module 131. Said final request is able to cause an action by the processing module 131 involving the television set 14.

In a step 316, the RPC server of the processing module 131 of the decoding device 13 receives the final request.

In one embodiment, during a step 317, following the reception of the final request, the action caused by the reception of the final request by the processing module 131 consists of re-launching the supply of each component of the first television programme paused during step 309 to the television set 14. The broadcasting of the television programme then resumes on the television set 14.

In one embodiment, the virtual-reality application is an MPEG-4 (ISO/IEC 14496) or WebM (https://www.webmproject.org/) video stream combined with metadata of a spherical video described in the document Spherical Video V2 RFC (https://github.com/google/spatial-media/blob/master/docs/spherical-video-v2-rfc.md) and in the document Spherical Video RFC (https://github.com/google/spatial-media/blob/master/docs/spherical/video-rfc.md). In this case, the processing module 161 must implement a video reader capable of decoding this type of stream and taking into account this spatialisation information in order to display the application correctly, taking into account in particular the movements of the virtual-reality helmet 16.

In one embodiment, the virtual-reality application is an interactive application such as for example a gaming application. The user plays the game that is offered to him and obtains a score (i.e. an interaction result). The action caused by the reception of the final request by the processing module 131 then depends on the score obtained.

For example, if the score obtained by the user is above a threshold, the user can pass to another television programme included in the data stream TS in replacement for the initial television programme. Otherwise the user does not change television programme.

In another example, if the score obtained by the user is above a threshold, the application is launched on the television set.

In another example, if the score obtained by the user is above a threshold, one of the components of the television programme is replaced by another component of the television programme. For example, a first soundtrack is replaced by a second soundtrack.

In another example, if the score obtained by the user is above a threshold, the new component of the television programme is supplied to the user.

In this embodiment, in a step 318, the RPC client implemented by the processing module 161 transmits the score obtained by the user to the RPC server implemented by the processing module 131.

In a step 319, the processing module 131 receives the score and decides on an action according to said score.

In one embodiment, the virtual-reality application is personalised according to the television programme. For example, the television programme is a football match broadcast live. The virtual-reality application is a three-dimensional animation depicting a football match. In this animation, it is possible to personalise shirts of the players in each team. The virtual-reality helmet 16 then receives the virtual-reality application in a non-personalised form and personalises it according to information on the television programme supplied by the decoding device 13. This information is for example extracted from EIT (Event Information Table) fields of DVB-SI tables included in the data stream TS.

In another embodiment, the additional content is a soundtrack in a language different from the language used up until then in the broadcasting of the television programme. The second client device 16 is for example a smartphone. In this embodiment, when the request for information is received, the processing module 131 causes the pausing of the supply to the television set 14 of the original audio component. The supply of the video component of the television programme for its part is not interrupted and this component is still continuously displayed by the television set 14. As from this moment, the television set 14 no longer broadcasts the original soundtrack of the television programme, but only the video component of the television programme. In step 313, the smartphone 16 broadcasts the additional content corresponding to a new soundtrack. At the end of the use of the additional content, the processing module 313 causes the restarting of the supply of the audio component corresponding to the original soundtrack.

In one embodiment, it is assumed that the processing module 131 has stored the television programme during the use of the additional content and that, in step 317, when the processing module 131 launches the supply of each component of the first television programme paused in step 309, it resumes supply of each component as from the moment of pausing. In this way, the user does not miss any part of the television programme during the pausing thereof.

FIG. 4 illustrates schematically a second example of a method for the combined broadcasting of a television programme and additional multimedia content according to the invention.

In the example in FIG. 4, the system 1 comprises two second client devices 16A and 16B identical to the client device 16. The second client device 16A comprises a processing module 161A and the second client device 16B comprises a processing module 161B. The processing modules 161A and 161B are identical to the processing module 161.

Step 300 of FIG. 4 is identical to step 300 of FIG. 3.

Steps 301A to 316A are identical respectively to steps 301 to 316.

Steps 301B to 308B and steps 310B to 317B are identical respectively to steps 301 to 308 and 310 to 317.

Step 309A is different from step 309. This is because, when a plurality of second client devices are connected to the decoding device 13, only the first request for information received from a connected second client device must cause the pausing of the supply of at least one component of the television programme.

Step 317B is different from step 317. This is because the action of the processing module 131 involving the television set 14 can be caused only by the reception of the last final request. In other words, it is necessary for the processing module to have received as many final requests as there are requests for information in order to cause said action.

1. A method for the combined broadcasting of a first television programme and additional multimedia content, the first television programme being broadcast continuously between a first server and a first client device via a decoding device, the decoding device receiving a data stream comprising the first television programme and extracting the first television programme from said data stream in order to supply it to the first client device, the additional multimedia content being stored on a second server and being intended to be played on at least one second client device, the first and second server being able to be two distinct servers or one and the same server, wherein the method comprises, when it is implemented by the decoding device:
extracting information representing the additional multimedia content from the data stream and, for each second client device, supplying, to the user of said second client device, by means of the first client device, a signal indicating that it is possible to obtain the additional multimedia content;
receiving a request, referred to as a request for information, with a view to obtaining information on the additional multimedia content, from at least one second client device, said information comprising an address of the second server;
transmitting said information on the additional multimedia content to each second client device that sent a request for information;
as soon as a first request for information is received, pausing the supply of at least one component of the first television programme at least as long as a request, referred to as the final request, indicating an end of use of the additional multimedia content is not received by the decoding device from each second client device that sent a request for information.

2. The method according to claim 1, wherein, following the reception of a final request, the decoding device resumes the supply of each component of the first television programme paused.

3. The method according to claim 1, wherein the additional multimedia content is content with which each user of a second client device receiving this additional multimedia content can interact and for which a result of interaction is obtained at the end of use of said additional multimedia content, and wherein the decoding device receives the interaction result and determines an action to be taken involving the first client device according to the interaction result.

4. The method according to claim 3, wherein the action to be taken comprises a supply of a second television programme included in the data stream to the first client device in replacement for the first television programme and/or a supply of at least one component of the first television programme different from each component paused to the first client device in replacement for or in addition to at least one component paused and/or a starting of an application on the first client device.

5. A method for the combined broadcasting of a first television programme and additional multimedia content, the first television programme being broadcast continuously between a first server and a first client device via a decoding device, the decoding device receiving a data stream comprising the first television programme and extracting the first television programme from said data stream in order to supply it to the first client device, the additional multimedia content being stored on a second server and being intended to be played on at least one second client device, the first and second server being able to be two distinct servers or one and the same server, wherein the method comprises, when it is implemented by a second client device:
transmitting a request, referred to as a request for information, to the decoding device with a view to obtaining information on the additional multimedia content, said information comprising an address of the second server, said request for information being transmitted by an action of a user of the second client device following an obtaining, by said user, of a signal indicating that it is possible to obtain the additional multimedia content, the signal having been sent by the first client device following an extraction from the data stream of information representing the additional multimedia content, the request for information being able to cause a pausing, by the decoding device, of the supply of at least one component of the first television programme to the first client device;
receiving said information on the additional multimedia content from the decoding device;
transmitting a request to obtain the additional multimedia content to the second server;
using the additional multimedia content following the reception thereof from the second server device;
transmitting a request, referred to as the final request, indicating an end of use of the additional multimedia content to the decoding device, said final request being able to cause an action of the decoding device involving the first client device.

6. The method according to claim 5, wherein the additional multimedia content is content with which the user of the second client device can interact and for which an interaction result is obtained at the end of use of said additional multimedia content, and wherein the second client device transmits the interaction result to the decoding device, the action taken by the decoding device being dependent on the interaction result.

7. A method for the combined broadcasting of a first television programme and additional multimedia content, the first television programme being broadcast continuously between a first server and a first client device via a decoding device, the decoding device receiving a data stream comprising the first multimedia stream and extracting the first television programme from said data stream in order to supply it to the first client device, the additional multimedia content being stored on a second server and being intended to be played on at least one second client device, the first and second server being able to be two distinct servers or one and the same server, wherein part of the method implemented by the decoding device comprises:
extracting information representing the additional multimedia content from the data stream and, for each second client device, supplying to the user of said second client device, by means of the first client device, a signal indicating that it is possible to obtain the additional multimedia content;
receiving a request, referred to as a request for information, with a view to obtaining information on the additional multimedia content from at least one second client device, said information comprising an address of the second server;
transmitting said information on the additional multimedia content to each second client device that sent a request for information;
as soon as a first request for information is received, pausing the supply of at least one component of the first television programme at least as long as a request, referred to as the final request, indicating an end of use of the additional multimedia content has not been received by the decoding device from each second client device that sent a request for information;
and wherein a part of the method comprises, for each second client device implementing the method:
transmitting the request for information to the decoding device with a view to obtaining the information on the additional multimedia content, said request for information being transmitted by an action of a user of the second client device following an obtaining, by said user, of the signal indicating that it is possible to obtain the additional multimedia content sent by the first client device;
receiving said information on the additional multimedia content from the decoding device;
transmitting a request to obtain the additional multimedia content to the second server;
using the additional multimedia content following reception thereof from the second server device;
transmitting the final request to the decoding device.

8. A decoding device continuously broadcasting a television programme to a first client device, the decoding device receiving a data stream comprising a first multimedia stream coming from a first server and extracting the first television programme from said data stream in order to supply it to the first client device, wherein the decoding device comprises electronic circuitry configured for:
extracting information representing an additional multimedia content from the data stream, the additional multimedia content being stored on a second server and being intended to be played on at least one second client device; the first and second server being able to be two distinct servers or one and the same server,
supplying, to each user of a second client device, by means of the first client device, a signal indicating that it is possible to obtain the additional multimedia content;
receiving a request, referred to as a request for information, with a view to obtaining information on the additional multimedia content, from at least one second client device, said information comprising an address of the second server;
transmitting said information on the additional multimedia content to each second client device that sent a request for information;
pausing the supply of at least one component of the first television programme as soon as a first request for information is received, the pausing being activated at least as long as a request, referred to as the final request, indicating an end of use of the additional multimedia content, is not received by the decoding device from each second client device that sent a request for information.

9. A client device, referred to as the second client device, able to connect to a decoding device continuously broadcasting a television programme to a first client device, the decoding device receiving a data stream coming from a first server comprising the first multimedia stream and extracting the first television programme from said data stream in order to supply it to the first client device, wherein the second client device comprises electronic circuitry configured for:
transmitting to the decoding device a request, referred to as a request for information, with a view to obtaining information on an additional multimedia content, the additional multimedia content being stored on a second server, the first and second server being able to be two distinct servers or one and the same server, said information comprising an address of the second server, said request for information being transmitted by the action of a user of the second client device following an obtaining, by said user, of a signal indicating that it is possible to obtain the additional multimedia content, the signal having been sent by the first client device following an extraction from the data stream of information representing the additional multimedia content, the request for information being able to cause a pausing by the decoding device of the supply of at least one component of the first television programme to the first client device;
receiving said information on the additional multimedia content from the decoding device;
transmitting a request to obtain the additional multimedia content to the second server;
using the additional multimedia content following reception thereof from the second server device;
transmitting a request, referred to as the final request, indicating an end of use of the additional multimedia content to the decoding device, said final request being able to cause an action involving the first client device by the decoding device.

10. A system, comprising a decoding device according to claim 8 and at least one client device, referred to as the second client device, able to connect to the decoding device continuously broadcasting a television programme to a first client device, the decoding device receiving a data stream coming from a first server comprising the first multimedia stream and extracting the first television programme from said data stream in order to supply it to the first client device, wherein the second client device comprises electronic circuitry configured for:
transmitting to the decoding device a request, referred to as a request for information, with a view to obtaining information on an additional multimedia content, the additional multimedia content being stored on a second server, the first and second server being able to be two distinct servers or one and the same server, said information comprising an address of the second server, said request for information being transmitted by the action of a user of the second client device following an obtaining, by said user, of a signal indicating that it is possible to obtain the additional multimedia content, the signal having been sent by the first client device following an extraction from the data stream of information representing the additional multimedia content, the request for information being able to cause a pausing by the decoding device of the supply of at least one component of the first television programme to the first client device;
receiving said information on the additional multimedia content from the decoding device;
transmitting a request to obtain the additional multimedia content to the second server;
using the additional multimedia content following reception thereof from the second server device;
transmitting a request, referred to as the final request, indicating an end of use of the additional multimedia content to the decoding device, said final request being able to cause an action involving the first client device by the decoding device.

11. (canceled)

12. A non-transitory storage medium, storing a computer program comprising instructions for the implementation, by a device, of the method according to claim 1, when said program is executed by a processor of said device.

13. A non-transitory storage medium, storing a computer program comprising instructions for the implementation, by a device, of the method according to claim 5, when said program is executed by a processor of said device.
